(19) United States
(12) Patent Application Publication
(10) Pub. No.: US 2026/0268072 A1
(43) Pub. Date: Sep. 10, 2026

(54) RETRIEVAL-AUGMENTED GENERATION SYSTEMS AND METHODS FOR REPORT GENERATION

(71) Applicant: BlueHalo, LLC, Huntsville, AL (US)

(72) Inventors: Onur Savas, Huntsville, AL (US); Sam Stolzoff, Huntsville, AL (US)

(21) Appl. No.: 19/558,998

(22) Filed: Mar. 6, 2026

Related U.S. Application Data
(60) Provisional application No. 63/768,638, filed on Mar. 7, 2025.

(51) Int. Cl. G06F 40/186; G06F 40/284

(52) U.S. Cl. CPC G06F 40/186; G06F 40/284

(57) ABSTRACT

A system for automatically generating a report including a query engine configured to: receive a query requesting generation of a report, wherein the query includes a report type and at least one user-specific parameter, select a report template from a plurality of report templates based on the report type, and generate a plurality of user-specific prompts based on a plurality of prompt templates corresponding to the selected report template and the at least one user-specific parameter. A vector engine is configured to retrieve data that is contextually relevant to the plurality of user-specific prompts from a vector database. A report engine is configured to: provide the plurality of user-specific prompts and the retrieved data to a large language model (LLM), generate, via the LLM, a plurality of answers corresponding to the plurality of user-specific prompts based on the retrieved data, and aggregate the plurality of answers into the selected report template to produce the report.

### CROSS-REFERENCE TO RELATED APPLICATIONS

This application claims priority to U.S. Provisional Application No. 63/768,638, filed on Mar. 7, 2025 and titled “RETRIEVAL-AUGMENTED GENERATION SYSTEMS AND METHODS FOR REPORT GENERATION,” the entire disclosure of which is hereby incorporated by reference.

### TECHNICAL FIELD

The present disclosure relates to the automatic generation of reports and in particular to retrieval-augmented generation (RAG) systems and methods for automatically generating reports.

### BACKGROUND

Various tools are available to aggregate publicly available information (PAI) and generate information, such as text, graphs, and other analytics, using artificial intelligence (AI) models. In some cases, these tools are used by analysts to compile reports on specific topics, such as open-source information reports (OSIRs), situational reports, and other reports that are intended to be ingested into government databases for access on classified or unclassified systems. While these tools can provide useful information, they often fail to present information in a manner that is easily understandable to end users (e.g., the analysts and/or the report audience). As such, analysts are typically tasked with manually digesting and transposing information in order to prepare reports. This process can be tedious and time consuming, making report generation expensive and inefficient. Further, such tools fail to consider specific report formats and criteria when aggregating and generating information. Accordingly, analysts often need to submit multiple requests to the tool in order to obtain the minimum information required to complete a report. In addition, analysts are often tasked with converting the generated information into a required report format, which is often enhanced or different compared to the report format provided by the report generating tool, adding to the existing inefficiencies of manual report generation.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

In various examples, the subject matter described herein relates to automatically generating a report using a retrieval-augmented generation (RAG) techniques. According to some embodiments, a system for automatically generating a report includes a query engine, a vector engine, and a report engine. The query engine receives a query requesting generation of a report. The query includes a report type and at least one user-specific parameter. The query engine selects a report template from a plurality of report templates based on the report type. The query engine generates a plurality of user-specific prompts based on a plurality of prompt templates corresponding to the selected report template and the at least one user-specific parameter. The vector engine retrieves data that is contextually relevant to the plurality of user-specific prompts from a vector database. The report engine provides the plurality of user-specific prompts and the retrieved data to a large language model (LLM). The report engine generates, via the LLM, a plurality of answers corresponding to the plurality of user-specific prompts based on the retrieved data. The report engine aggregates the plurality of answers into the selected report template to produce the report.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a block diagram of a report generation system, in accordance with some embodiments.

FIG. 2A is a diagram of an example report template, in accordance with some embodiments.

FIG. 2B is a diagram of an example prompt template of the report template of FIG. 2A, in accordance with some embodiments.

FIG. 3 is a flow diagram of an example workflow of the report generation system of FIG. 1, in accordance with some embodiments.

FIG. 4 is a block diagram of a report generation system, in accordance with some embodiments.

FIG. 5 is a flow diagram of an example workflow of the report generation system of FIG. 4, in accordance with some embodiments.

FIG. 6 is a block diagram of a report generation system, in accordance with some embodiments.

FIG. 7 is a flow diagram of an example workflow of the report generation system of FIG. 6, in accordance with some embodiments.

FIG. 8 is an example computing device, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

As discussed above, various tools are available to aggregate publicly available information (PAI) and generate information, such as text, graphs, and other analytics, using artificial intelligence (AI) models. These tools may be used by analysts to compile reports on specific topics, such as open-source information reports (OSIRs), situational reports, and other reports that are intended to be ingested into government databases for access on classified or unclassified systems. While these tools can provide useful information, they often fail to present information in a manner that is easily understandable to end users (e.g., the analysts and/or the report audience). As such, analysts are typically tasked with manually digesting and transposing information in order to prepare reports. This process can be tedious and time consuming, making report generation expensive and inefficient.

In many cases, these PAI-based tools fail to consider specific report formats and criteria when aggregating and generating information (e.g., formats and criteria of OSIRs, situational reports, etc.). As such, in order to prepare a report, analysts often need to submit multiple requests in order to obtain the minimum information required (or mandated) for the report. These existing PAI-based tools often increase the time required to produce reports and products that support various government activities. This can be a significant drawback, as it hampers the timely delivery of intelligence, psychological operations, logistics reports, civil affairs support, communications planning, exercise planning, and other critical areas that rely on open-source data and information. In some cases, language barriers can pose significant challenges when dealing with open source data and information. Current PAI-based tools often require expensive and time-consuming translation processes or programs, which can be cumbersome and costly.

In addition, PAI-based tools struggle to provide information that is ready for quality control, quality assurance, and dissemination processes. PAI-based tools typically lack a format and/or template that aligns well with government data management and information management processes. As such, analysts are often tasked with converting information generated by PAI-based tools into a preferred (or required) report format, adding to the inefficiencies of manual report generation. The limitations of such PAI tools and the current challenges in creating reports acceptable to government customers highlight the need for innovation in the field. As such, there is a need to overcome these limitations and challenges experienced by existing PAI-based tools, particularly with respect to the generation of reports.

Accordingly, improved systems and methods for using retrieval-augmented generation (RAG) techniques to generate reports of desirable format and content are provided herein. In at least one embodiment, the system is configured to receive a query requesting the generation of a report. The query may include a report type and at least one user-specific parameter. The system is configured to (i) select a report template from a plurality of report templates based on the report type and (ii) generate a plurality of user-specific prompts based on a plurality of prompt templates corresponding to the selected report template. The system retrieves (or receives) data that is contextually relevant to the plurality of user-specific prompts from at least one database. In some embodiments, the data is retrieved using a retrieval-augmented generation (RAG) technique. The plurality of user-specific prompts and the retrieved data are provided to a large language model (LLM). The LLM may be included in the system or is otherwise accessible by the system. The LLM generates a plurality of answers corresponding to the plurality of user-specific prompts based on the retrieved data and the system produces the report by aggregating the plurality of answers into the selected report template. In some embodiments, the generated report seamlessly integrates with government data management and information management processes, improving the efficiency of the report generation process while reducing costs associated with the report generation process.

In some examples, and contrary to existing methods and systems, by streamlining the aggregation of highly relevant and tailored data with data processing, data exploitation, and report generation processes, the embodiments provided herein can improve report generation accuracy while eliminating the need for manual intervention. In addition, the embodiments provided herein reduce the time and effort required to collect, process, and analyze data for report generation. This can lead to increased efficiency and productivity, allowing analysts and customer teams to focus on more meaningful and creative work. The embodiments provided herein may provide for the ability to answer any question about any geographic location on earth, enabling informed decision-making. For example, customer teams can gain insights from a wide range of data sources and perform comprehensive analysis, leading to more accurate and informed decisions. The reports generated by the embodiments provided herein can inform any discipline and can cater to the diverse needs of different customer teams. Whether it's in the fields of finance, healthcare, defense, or any other discipline, the ability to provide relevant and tailored information is valuable for addressing specific challenges and driving outcomes.

In some examples, the selection and use of a report template enables the system to retrieve the most relevant information for generation of the report (e.g., from a PAI database), which differentiates the disclosed system from existing systems that lack such refinement. The prompts of the report template provide a structure for the LLM to use the retrieved information to generate the report. As such, the quality of the report does not depend entirely on the type or order of prompts being manually fed to an LLM by the analyst (which may vary between analysts and/or reports). Further, the amount of institutional knowledge and training needed to generate the report can be lowered, allowing non-specialized users to use the report generation system provided herein. In some examples, an analyst may use the system to generate a report by providing only the type of report and basic parameters to the system.

In addition, the capability to produce reports in any templated format can be significant to government customers. Different agencies and departments often have specific reporting requirements, and the ability to generate reports in the desired format ensures compatibility and seamless integration with existing government databases and systems. Automating the process of analysis and creating informational reports in government template formats offers several benefits. First, by automating the analysis process, the embodiments provided herein can reduce the manual effort required for data analysis. This streamlines the workflow and allows government teams to generate insights and make informed decisions more efficiently. Second, the ability to produce reports in government template formats ensures easy integration with existing government databases and systems. This facilitates the quick dissemination of information to relevant stakeholders and enables efficient data management and information sharing within government agencies. Third, the automation of analysis and report generation leads to a productivity increase for government customers. By reducing manual tasks and providing readily available reports, the invention enables government teams to focus on higher-value activities and achieve their objectives more effectively. In addition, automating the report generation process can eliminate or suppress human-related errors that are prevalent in manual report generation.

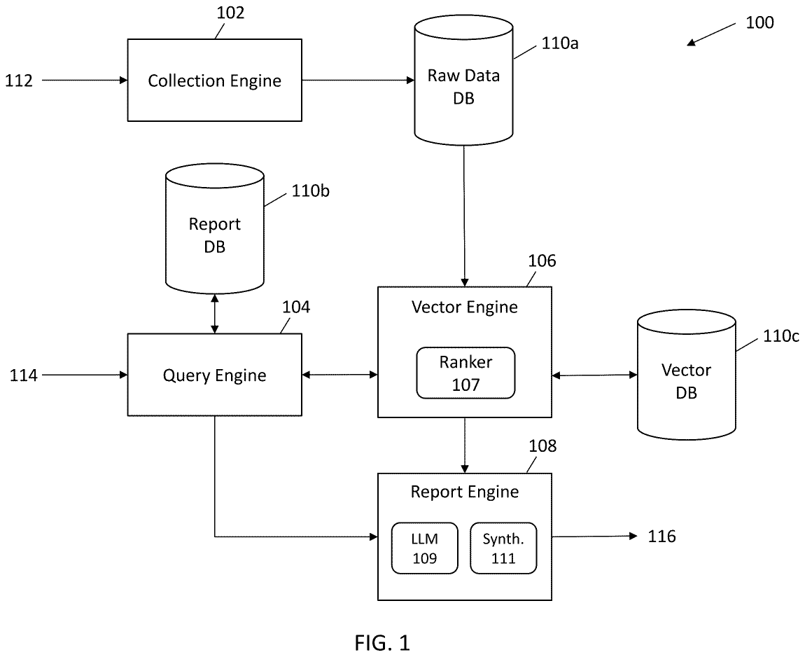

FIG. 1 is a block diagram of a report generation system 100 in accordance with aspects described herein. In some examples, the system 100 includes a collection engine 102, a query engine 104, a vector engine 106, and a report engine 108. In some examples, the engines of the system 100 are implemented by one or more application servers. Each application server may comprise software components that can be deployed at one or more data centers in one or more geographic locations, for example. The software components can include subcomponents that can execute on the same or on a different individual data processing apparatus. In some examples, the system 100 includes (or is configured to access) a raw data database 110a, a report database 110b, and a vector database 110c. The databases 110a, 110b, and 110c can reside in one or more physical storage systems in one or more geographic locations.

The system 100 applies RAG with advanced vectorization techniques and customized templating capabilities to produce highly specialized, actionable reports. In some examples, the system 100 leverages a sequence of task-oriented prompts that are designed to align with government doctrines, field manuals, and best practices. By ensuring that generated reports adhere to established guidelines, the system 100 can provide a level of consistency and reliability essential for both government and commercial applications. In some examples, the task-oriented prompts are generated based on specialized knowledge of doctrine, techniques, tactics, and procedures associated with government and commercial applications.

In some examples, the collection engine 102 is configured to retrieve and ingest publicly available data 112. The collection engine 102 collects PAI from various sources, including social media platforms and news websites. In some examples, the collection engine 102 includes, or utilizes, web scraping tools, application programming interfaces (APIs), and data parsing libraries to gather data in different formats (e.g., text, Hypertext Markup Language (HTML), or JavaScript Object Notation (JSON)). The data 112 retrieved by the collection engine 102 may include social media posts, news articles, website content, database content, or any other form of publicly available data. In some examples, the data 112 is stored in the raw data database 110a.

The vector engine 106 is configured to convert the data stored in the raw data database 110a (e.g., the data 112) into numerical vectors for efficient storage and retrieval. In some examples, the numerical vectors (i.e., the vectorized components) represent the textual content of the data 112. The numerical vectors may also represent (or include) metadata associated with the data 112 (e.g., an author of the textual content, a date when the textual content was published, a web address where the textual content was published, etc.). The vector engine 106 may vectorize the data 112 using one or more tokenization techniques. For example, the vector engine 102 may employ tokenization and embedding generation techniques using embedding models (e.g., OpenAI text-ada-002) to create vector representations of the data 112. In some examples, the resulting vectors, along with their associated metadata, are stored in the vector database 110c. In some examples, the vector database 110c is a vector database optimized for handling high-dimensional vectors (e.g., PostgreSQL or OpenSearch). The vectorization (or tokenization) of data allows for efficient and precise retrieval from the vector database 110c. In some examples, the vector database 110c supports similarity search, nearest neighbor search, and/or efficient indexing.

The query engine 104 allows users to query data (or metadata) stored in the vector database 110c. In some examples, such queries can include Boolean syntax that enables the selection of specific sets of PAI tailored to the user's needs. For example, users may input queries (e.g., via a user interface (UI), not shown in FIG. 1) using metadata fields and Boolean operators. In some examples, the vector engine 106 is configured to vectorize (or tokenize) at least a portion of the user's query to facilitate retrieval from the vector database 110c. In some examples, the retrieved data is presented to the user via the UI. In some examples, the query engine 104 is configured to search both the raw data database 110a and the vector database 110c. In such examples, the query engine 104 may search the raw data database 110a using a natural language form of the user's query.

The system 100 enables users to create and manage report templates that can be customized for any geographic location, covering any subject, and addressing any discipline, from intelligence support to marketing. This customization ensures that reports generated by the system 100 are highly relevant to the user's specific context and requirements. In some examples, the report engine 108 enables users to define and manage report templates via the UI. Each report template represents a structure or framework for generating a particular report. For example, each report template may correspond to a specific customer, subject, discipline, standard, or any combination thereof. The report engine 108 may allow users to upload, create, or edit report templates (e.g., via the UI). In some examples, the user can create a template by uploading one or more examples of a particular report type. In some examples, the report templates are stored in the report database 110b.

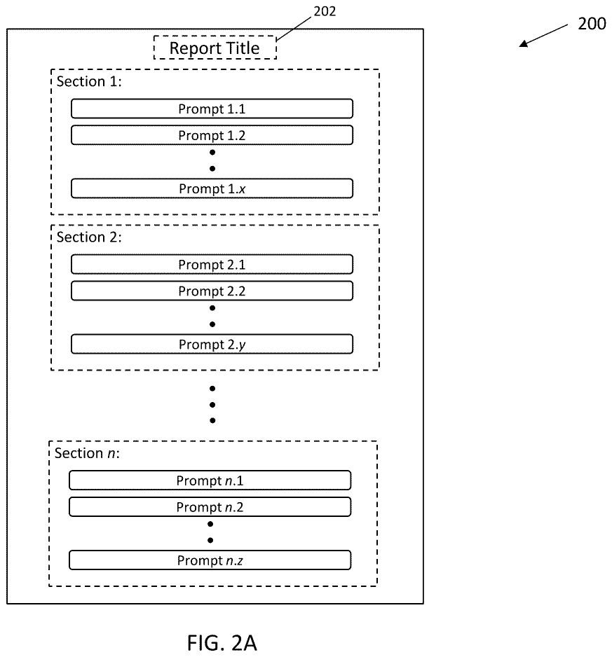

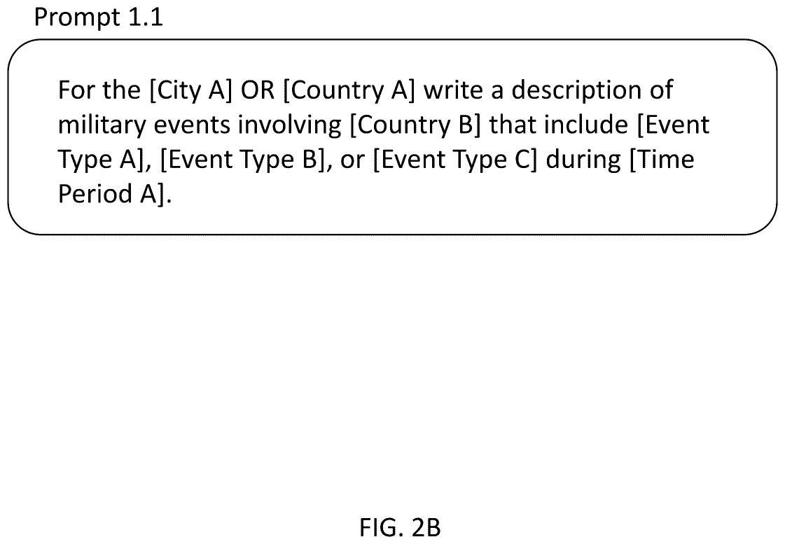

FIG. 2A illustrates an example of a report template 200 in accordance with aspects described herein. The report template 200 includes multiple sections (or placeholders) for dynamic content. As shown in FIG. 2, the report template 200 includes n sections (e.g., Section 1, Section 2, etc.). In some examples, each section corresponds to a different topic (or sub-topic) of the report template. It should be appreciated that some report templates may include only one section (e.g., n=1). Each section can include static content (e.g., boilerplate text) combined with dynamic content. In some examples, the dynamic content corresponds to one or more prompt templates that are associated with the section. For example, each section may have a predefined set of parametrized prompt templates that are used to generate the dynamic content of the section. In some examples, an individual section may have only one parametrized prompt template. The number of parametrized prompt templates associated with each section may vary without limitation. As illustrated in FIG. 2A, Section 1 has x prompt templates, Section 2 has y prompt templates, and Section n has z prompt templates.

FIG. 2B illustrates an example for Prompt 1.1 of Section 1 in FIG. 2A. As shown, the prompt template recites “For the [City A] OR [Country A] write a description of military events involving [Country B] that include [Event Type A], [Event Type B], or [Event Type C] during [Time Period A].” The bracketed terms (e.g., City A, Country A, etc.) are variable parameters placeholders that are populated in the prompt to generate dynamic content for the report. For example, user-specific parameters may be integrated into the variable parameter placeholders to generate a user-specific prompt. As described in greater detail below, such parameters may be provided by one or more users generating the report. In some examples, the parametrized prompt templates are created by the user(s) that create the report template 200. In some examples, the parametrized prompt templates are automatically generated by the system 100 (e.g., the report engine 108) based on example reports (e.g., past actual reports, mock reports, synthetic reports, etc.) used to create the report template 200. In some examples, the parametrized prompt templates are automatically generated by the system 100 (e.g., the report engine 108) based on requirements provided to the system 100 for a particular report or report template (e.g., customer requirements).

As shown in FIG. 2A, the report template 200 may include additional features, such as a report title 202. In some examples, the report title 202 is a static title. In some examples, the report title 202 includes a parametrized prompt (or template) that is used to generate a dynamic title (e.g., based on user-provided parameters). While not shown, the report template 200 may include style parameters for the final report (e.g., font size, font type, spacing, page limit, etc.) and/or any desirable indicia, watermarks, and the like.

Returning to FIG. 1, the vector engine 106 includes a ranker module 107 that is configured to identify the most relevant PAI data from the vector database 110c, which is then processed by an LLM 109 of the report engine 108 to answer the user-specific prompts generated from the report template 200. The ranker module 107 ranks the retrieved PAI data based on relevance to each prompt of the report template 200. In some examples, the ranker module 107 uses vector similarity metrics to rank the retrieved vectors (i.e., the retrieved PAI data). In some examples, the report engine 108 includes a synthesizer module 111 that is configured to evaluate the answers generated by the LLM 109 for quality and relevance. The synthesizer module 111 may ensure that the generated answers meet any required report standards before the report engine 108 compiles (or aggregates) them into a final report 116. In some examples, the synthesizer module 111 uses cosine similarity metrics to evaluate quality and relevance. If the generated answers do not meet such standards, the system 100 iterates through the RAG process again, refining the outputs until satisfactory results are achieved. This iterative evaluation and refinement process enables the system 100 to produce comprehensive and accurate reports.

In some examples, the system 100 is configured to generate reports that are consumable by databases on both unclassified and restricted customer systems (e.g., government systems). By generating customer-compliant reports, the system 100 can provided seamless data fusion with sources on such customer systems, enhancing the usability and accessibility of the reports for analysts and decision-makers. The ability to integrate smoothly with customer systems ensures that the information can be effectively used within existing workflows and databases. In some examples, the user-specific prompts consist of task-oriented instructions for the LLM 109, such as “write a report” or “create a timeline.” These instructions guide the LLM 109 in generating specific types of information based on the desired subject matter. By structuring the prompts in this way, the report engine 108 can generate targeted and focused reports that address specific commercial or government requirements.

In some examples, the user-specific prompts provided to the LLM 109 include instructions to summarize the generated text (or answers) and derive additional insights, resulting in information of predictive value. This predictive capability can be highly valuable for decision-makers in commercial and government organizations, enabling them to anticipate future scenarios and make informed choices. The comprehensive and thorough reports produced by the system 100 allow for in-depth analysis and coverage of various aspects of operations, providing a holistic view of the relevant subject matter. This comprehensive approach allows analysts and decision-makers to refine information into actionable insights upon which important decisions can be based. This predictive capability can be highly valuable for commercial and government enterprises, as it allows them to proactively steer their organizations and make informed decisions based on potential future developments. In some examples, predictive insights, indicators, and warnings support decision-makers in commercial and government organizations. By providing information on possible futures and indications of their occurrence, decision-makers can make informed choices and develop strategies to navigate potential scenarios. This capability can be particularly valuable for organizations that need to consider various possibilities and plan accordingly.

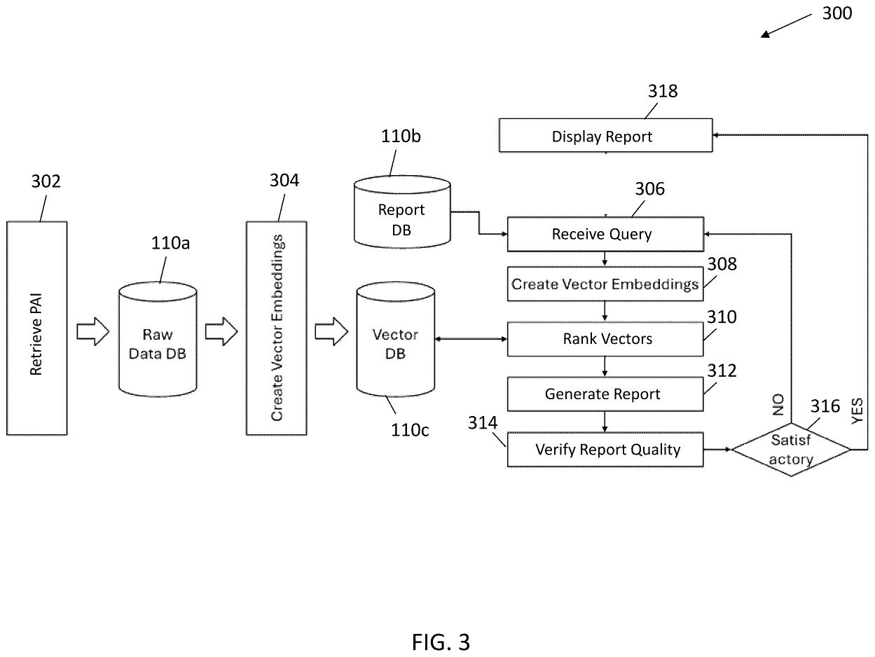

FIG. 3 is a flow diagram illustrating a workflow 300 used by system 100 in accordance with aspects described herein. Specifically, system 100 can use workflow 300 to generate a report, such as the report 116 in FIG. 1, according to some embodiments.

At step 302, the collection engine 102 retrieves PAI data from one or more external sources. As described above, the PAI data (data 112) collected by the collection engine 102 may include social media posts, news articles, website content, database content, or any other form of publicly available data without limitation. In some embodiments, the data 112 is stored by the collection engine 102 in the raw data database 110a in its original format (e.g., text). It should be appreciated that the collection engine 102 may retrieve commercially available information (CAI) in addition to PAI data, or instead of PAI data. CAI data is collected, aggregated, and sold by private-sector entities, making it accessible for purchase or licensing by businesses, researchers, and government agencies. CAI data may include, without limitation, consumer and demographic information (e.g., names and addresses), business intelligence information (e.g., insights into company financials, industry trends, and market analysis), geospatial data (e.g., mapping information, real estate records, and location tracking), and the like.

At step 304, the vector engine 106 converts the data 112 stored in the raw data database 110a into numerical vectors (or vector embeddings). In some examples, the vector engine 106 is configured to preprocess the data 112 before converting it into numerical vectors. For example, the vector engine 106 may clean and/or normalize the text of data 112 to prepare for vectorization. In some examples, the vector engine 106 is configured to break the data 112 into tokens. The tokens may correspond to smaller, more digestible chunks of text. In some examples, the vector engine 106 includes, or is configured to utilize, at least one pretrained model (e.g., an LLM) to generate vectors, or vector embeddings, representing the semantic content of the data 112. As described above, the text-to-vector conversion provides for efficient storage and retrieval. The vectorized data is then stored by the vector engine 106 in the vector database 110c. In some examples, the vector engine 106 is further configured to store metadata associated with the vectors in the vector database 110c. By way of example and not limitation, the vector engine 106 may store metadata indicating sources, dates, timestamps, and/or keywords associated with the vectorized data.

At step 306, the query engine 104 receives the query 114 requesting generation of a report. In some examples, the query 114 may be received from a single or multiple users. However, in other examples, the query 114 is received from another system or service. In some examples, the query 114 includes an indication of a desired report type and one or more user-specific parameters. In some examples, the query 114 corresponds to a generic report request. In such examples, the query engine 104 may prompt the user (e.g., via the UI) to enter (or select) a report type and one or more user-specific parameters.

Upon identifying the report type and the user-specific parameters, the query engine 104 is configured to select a report template from the report database 110b (e.g., report template 200 of FIG. 2A). As described above, the report template includes a predefined set of parametrized prompt templates which are used to generate dynamic content for the report. In some examples, the query engine 104 prompts the user to provide additional information (e.g., additional parameters) based on the predefined set of parametrized prompt templates associated with the selected report template. For example, the query engine 104 may communicate prompts and messages to the user via the UI to collect additional parameters that are relevant to the predefined set of parametrized prompt templates. The query engine 104 can be configured to generate a plurality of user-specific prompts by integrating the user-specific parameters into the predefined set of parametrized prompt templates. In some examples, the query engine is configured to insert the user-specific parameters into the variable parameter placeholders of the parametrized prompt templates (e.g., the bracketed terms in FIG. 2B).

At step 308, the vector engine 106 converts at least a portion of the user-specific prompts into numerical vectors (or vector embeddings). In some examples, the vector engine 106 is configured to convert each prompt in its entirety into a corresponding vector (or vectors). In some examples, the vector engine 106 is configured to break each prompt into multiple tokens and to convert the tokens into corresponding vectors. In some examples, the vector engine 106 is configured to convert the user-specific parameters of the prompts into vectors. The vector engine 106 may convert the user-specific prompts, or portions thereof, into vectors as described above in step 304. In some examples, the vectorized prompts are stored by the vector engine 106 in a database (e.g., the report database 110b or the vector database 110c).

At step 310, the vector engine 106 retrieves vectors from the vector database 110c that are contextually relevant to the user-specific prompts. In some examples, the vector engine 106 is configured to identify relevant vectors in the vector database 110c by performing a similarity search. The similarity search may include comparing the vectorized data in the vector database 110c to the vectorized prompts generated in step 308. In some examples, the vectorized data that is most numerically similar to the vectorized prompts is considered to be the most relevant data. In some examples, the ranker module 107 of the vector engine 106 is configured to rank the vectorized data from the vector database using one or more similarity metrics (e.g., numerical similarity). In some examples, the ranker module 107 creates a plurality of rankings for the vectorized data where each ranking corresponds to a prompt of the predefined set of parametrized prompts (or the corresponding user-specific prompts). In other words, the ranker module 107 may create unique vectorized data rankings that are specific to each prompt of the predefined set of parameterized prompts. In some examples, the ranker module 107 creates a singular ranking for the predefined set of parametrized prompts (or the corresponding user-specific prompts). In such cases, vectors having relevance to multiple prompts may be ranked higher than vectors having relevance to fewer or only one prompt.

At step 312, the report engine 108 generates the report (e.g., the report 116 of FIG. 1). The report 116 is generated using a RAG process that includes generating content for the report 116 based on the data retrieved in step 310. For example, all of the data retrieved in step 310 may be provided to the LLM 109 of the report engine 108 for use during report generation. In some examples, a portion of the data retrieved in step 310 is provided to the LLM 109. For example, a dataset may be provided to the LLM 109 that corresponds to a predetermined number of vectors selected from the data retrieved in step 310. In some examples, the predetermined number of vectors are selected based on the rankings assigned by the ranker module 107 (e.g., top 10 vectors, top 100 vectors, top 1000 vectors, and so on.). In some examples, the predetermined number of vectors is fixed for all report templates. In some examples, the predetermined number of vectors varies based on the selected report template. For example, the predetermined number of vectors may be a function of the number of prompts included in the report template (e.g., number of vectors increases with the number of prompts). In some examples, the predetermined number of vectors corresponds to the nature of the report. For example, the predetermined number of vectors may be a function of the scope of the report (e.g., number of vectors increases with wider scope). The vector engine 106 may be configured to convert the vectorized data into text before it is provided to the report engine 108 (or the LLM 109). In some examples, the vectorized data is provided directly to the LLM 109 of the report engine 108. In such cases, the LLM 109 may convert the vectorized data into text.

To generate the report 116, the report engine 108 is configured to feed the user-specific prompts to the LLM 109, which generates corresponding answers (or content) based on the contextually relevant data provided to the LLM 109. The report engine 108 is configured to aggregate the answers generated by the LLM 109 into the report template 200. For example, the answers (or content) generated by prompts 1.1-1.x may be aggregated in Section 1 of the report template 200, the answers (or content) generated by prompts 2.1-2.y may be aggregated in Section 2 of the report template 200, and so on. In some examples, the LLM 109 is instructed (e.g., by the prompts of the report template 200) to summarize generated text and derive additional insights. As such, the LLM 109 may provide predictive insights based on the text generated from the prompts. In some examples, the LLM 109 is instructed to generate the report content with a particular context. For example, the LLM 109 may be instructed to generate answers (or content) from the perspective of a reporter, an agent, a researcher, etc. In some examples, the LLM 109 is instructed to generate answers (or content) in two or more different languages (e.g., English, Chinese, French, etc.). Alternatively, the LLM 109 may be instructed to (i) generate the report and (ii) revise the report (e.g., add context/perspective, convert to different languages, etc.).

At step 314, the report engine 108 verifies (or assesses) the quality of the report 116. In some examples, the synthesizer module 111 of the report engine 108 is configured to generate report metrics that indicate the quality of the report 116 (or the individual answers). As described above, the synthesizer module 111 may generate one or more cosine similarity metrics which indicate the quality and/or accuracy of the report 116. In some examples, the report metrics are generated for the entire report 116. In some examples, the report metrics are generated for portions of the report 116 (e.g., sections of the report template or individual answers generated by the LLM 109).

At step 316, the report engine 108 determines whether the report 116 is satisfactory. In some examples, the report 116 is determined to be satisfactory based on the report metrics generated by the synthesizer module 111 in step 314. The report metrics can include, without limitation, scores or values that measure logical consistency, entity consistency, fluency and readability, engagement, usefulness, and the like. In some examples, the report metrics may vary based on the report type (or template). In some examples, the user may select one or more preferred report metrics to be used.

One or more thresholds may be used to determine whether the report 116 is satisfactory. If the report 116 is determined to be satisfactory (e.g., the report metrics are over the one or more thresholds), then the report 116 is displayed to the user at step 318. In some examples, the report 116 may be automatically entered into a customer database (e.g., a government or commercial database system). If the report 116 is determined to be unsatisfactory (e.g., at least one report metric is below a threshold), then the report 116 may be revised through RAG iteration. In some examples, the report 116 is revised by returning to step 306. In such cases, the user may be prompted to provide additional information (e.g., additional parameters for prompts). In some examples, the report engine 108 can instruct the query engine 104 to select different prompt templates or variations of prompt templates to include in the report template 200. In some examples, the report engine 108 can instruct the vector engine 106 to provide more or less data to the LLM 109 (e.g., by varying the predetermined number of vectors that are selected from the vector rankings). Based on such changes, the LLM 109 can regenerate the report 116 or portions of the report 116 to improve accuracy and quality.

As described above, the system 100 incorporates a sophisticated vector engine 106 that uniquely integrates advanced storage, retrieval, and filtering capabilities for optimal performance. In some examples, the vector engine 106 employs a “filter-while-search” mechanism, leveraging the Facebook AI Similarity Search (FAISS) engine. In such examples, the vector engine 106 first applies metadata filters to identify a subset of relevant document IDs (i.e., filterIds) and then performs an Approximate Nearest Neighbor (ANN) search, restricting the computation to these filtered IDs. This dual-step process ensures efficient querying by balancing precision and scalability. The vector engine 106 intelligently determines whether to execute an ANN search on the filtered subset or switch to an exact search, depending on the subset's size and other parameters. For example, if the subset is small, the vector engine 106 prioritizes accuracy by conducting an exact search rather than relying on the potentially less accurate ANN.

In some examples, the vector engine 106 performs vectorized searches utilizing ANN algorithms, such as the Hierarchical Navigable Small World (HNSW) algorithm, to achieve both speed and scalability. Unlike naive k-nearest neighbor solutions, which compute distances exhaustively and are computationally prohibitive for large datasets, the HNSW algorithm reduces latency by building a graph data structure that allows for efficient graph traversal methods. This algorithm capitalizes on the “small world” property to minimize the number of edges in shortest paths and the “navigable” property to guide the greedy traversal algorithm toward high-accuracy results. By leveraging these properties, the vector engine 106 ensures logarithmic query time even with large datasets.

In some examples, the vector engine 106 is dynamically configured based on optimization parameters. Such optimization parameters further enhance the adaptability of the vector engine 106 by influencing how the vector engine 106 balances speed, accuracy, and computational efficiency during vector search operations. Each parameter plays a distinct role in determining the engine's behavior. In some examples, the optimization parameters include N (Total Documents), P (Filtered Subset Size), k (Max Results), R (Results After Filtered ANN), FT (Filtered Exact Search Threshold), and MDC (Max Distance Computations).

The N (Total Documents) parameter represents the size of the entire dataset indexed in the vector engine 106. As N grows, the computational cost of brute-force searches becomes prohibitive, making approximate methods like HNSW essential for maintaining low latency. A large N underscores the need for efficient filtering and indexing strategies to ensure scalability.

The P (Filtered Subset Size) parameter represents the number of documents in the narrowed-down subset eligible for vector search after applying metadata filters. If P is large relative to N, the ANN search is more advantageous as it significantly reduces computational overhead while maintaining acceptable precision. Conversely, if P is small, exact search becomes preferable to ensure the highest accuracy, as the relative impact of approximation errors in a small dataset is more pronounced.

The k (Max Results) parameter defines the maximum number of results returned by the vector search. A small k reduces computational load, as fewer nearest neighbors need to be computed. However, a too-small k might miss less-relevant but contextually valuable results, especially in broader searches. Optimizing k ensures a balance between comprehensiveness and efficiency.

The R (Results After Filtered ANN) parameter indicates the number of results retrieved post-ANN search when filters are applied. If R is too low, it could limit the diversity of retrieved results, potentially missing valuable matches. Adjusting R in tandem with k allows fine-tuning to maintain relevance without overwhelming downstream systems with excessive data.

The FT (Filtered Exact Search Threshold) parameter defines when the vector engine 106 switches from ANN to exact search based on P. A well-tuned FT ensures that exact search is triggered only when the subset is small enough to justify the additional computational cost for the gain in accuracy. Setting FT too high might unnecessarily default to exact search, while setting it too low risks sacrificing precision in smaller subsets.

The MDC (Max Distance Computations) parameter sets a hard limit on the number of distance computations allowed in an exact search if FT is not defined. MDC provides a safeguard against excessive computational cost, ensuring the system remains performant even in edge cases. However, this limit must be carefully calibrated to avoid prematurely truncating searches, which could result in incomplete or less-accurate results.

By intelligently managing the optimization parameters, the vector engine 106 dynamically adapts to varying query and dataset conditions. For instance, during broad searches with minimal filtering, P may approach N, making ANN the ideal choice for efficiency. On the other hand, highly specific queries that result in small P values benefit from exact search to maximize accuracy. This flexibility ensures that the vector engine 106 delivers fast, accurate, and contextually relevant results across a wide range of use cases.

In some examples, the vector engine 106 incorporates a sophisticated chunking algorithm tailored to handle diverse types of PAI, including social media data, news articles, publications, blogs, and comments. Chunking is essential for adapting the varying lengths and structures of these text types to the fixed input limitations of the vector engine 106, which operates within a defined token window size.

For short texts, such as social media posts, chunking is straightforward since these texts typically fit within the token limit of the vectorizer (i.e., the vector engine 106). However, for longer texts, such as news articles, the chunking algorithm dynamically splits the content by paragraph. Each paragraph is tokenized to determine its token count, and the paragraphs are sequentially aggregated into chunks without exceeding the defined token limit (e.g., 256 tokens). This strategy ensures efficient utilization of the N-dimensional capacity of the vector engine 106 (e.g., 1024) while maintaining the coherence of information within each chunk.

For structured documents, such as publications where page numbers are known, chunking algorithm splits the content in alignment with page boundaries. If a single page exceeds the token limit, it is further split using the paragraph aggregation method. An important exception applies to documents containing section headers. Recognizing the importance of maintaining the contextual integrity of sections, the chunking algorithm prioritizes splitting at these headers to preserve the logical flow of content. This approach ensures that each chunk represents a cohesive unit of information, aiding in the accuracy of vector representation and subsequent retrieval processes.

The multi-faceted chunking algorithm enhances the ability of the vector engine 106 to process varied textual data effectively, ensuring that long-form content is chunked intelligently while preserving meaning and relevance. By combining data-type-specific strategies with token-aware chunking, the vector engine 106 optimizes both the granularity and coherence of its vectorized representations, enabling robust performance across diverse PAI sources.

As described above, the system 100 uses sets of doctrine-tailored, parameterized prompts to generate comprehensive reports for various customers and applications. The system 100 provides several advantages and benefits over existing PAI solutions. In some examples, the system 100 can use report templates that leverage government doctrine (e.g., field manuals) to ensure that the generated reports align with established guidelines and best practices that are expected (or defined) by the customer. This alignment enhances the credibility and relevance of the reports, making them more valuable for government and commercial purposes. In addition, the ability to create custom report templates is important for customers who often have specific reporting requirements (e.g., the government). By providing reports in the customer's desired format, the system 100 can ensure compatibility and seamless integration with existing customer databases and systems.

In some examples, the system 100 produces reports in an informational format, with good grammar, sourcing, citations, and academic rigor. By providing accurate and holistic information, the system 100 enhances the value and reliability of reports, enabling government users to make informed decisions based on trustworthy data. Likewise, the system 100 may enable end users to produce reports seamlessly in any language. This can eliminate the need for expensive and time-consuming translation processes, making information accessible in multiple languages. Overcoming language barriers enhances the usability and reach of the reports. The reports generated by the system 100 are comprehensive and can be generated with any desired length (e.g., up to 10 pages, 50 pages, 1000 pages, etc.). This customizable length allows for in-depth analysis and coverage of various aspects of operations, providing a holistic view of the relevant subject matter. The comprehensive nature of the reports enhances the value and reliability of the information presented to analysts and customers. Further, the prompts used by the system 100 can include instructions for the LLM 109 to summarize the generated text and derive additional insights. This predictive capability enables decision-makers to anticipate future scenarios and develop indicators and warnings. By providing predictive insights, the system 100 supports proactive decision-making and strategic planning.

As described above, existing PAI-based tools often rely on analysts to manually digest and transpose information in order to prepare reports. This process can be tedious and time consuming, making report generation expensive and inefficient. As such, by automating the process of report generation, the system 100 can eliminate the need for manual intervention and reducing the time and effort required to collect, process, and analyze data. This time efficiency allows analysts and customer teams to focus on more meaningful and creative work, increasing overall productivity. In addition, automating the report generation process can eliminate or suppress human-related errors that are introduced through manual intervention. In some examples, capability of the system 100 to produce reports in plain English and other languages improves accessibility for end users. It eliminates the need for specialized training or expertise in complex interfaces, making it easier for non-technical users to generate reports and access valuable information. This accessibility empowers a broader range of government personnel to leverage open source data and make informed decisions. In addition, by streamlining the report generation process, the system 100 can provide cost savings for customers. By providing a more efficient and cost-effective solution, the invention offers a competitive edge over existing PAI tools that may be expensive and resource-intensive.

In some examples, the system 100 can be configured to provide additional features and functions. For example, the system 100 may be configured to generate customized reports based on estimated locations of where photos and videos were taken from to assist in refining the geo-estimation of such photos and videos. In some examples, the system 100 can be configured to enable real-time chat-based interactions to provide geographic information, leveraging data from advertising technology, social media, and news sources to generate comprehensive reports based on the presence or absence of supporting information.

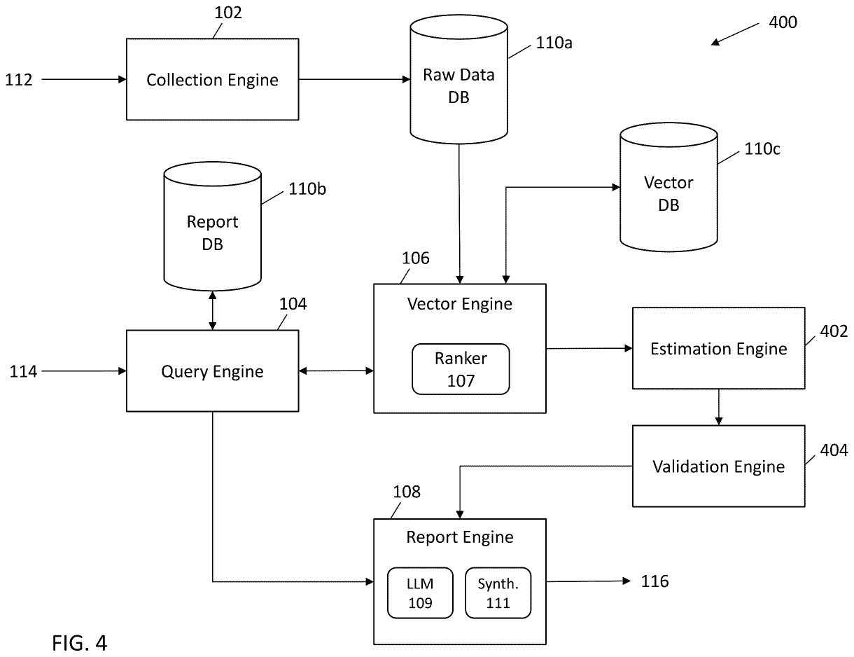

FIG. 4 is a block diagram of a report generation system 400 in accordance with aspects described herein. The system 400 is substantially the same as the system 100 of FIG. 1, except the system 400 includes an estimation engine 402 and a validation engine 404. The estimation and validation engines 402, 404 may be standalone engines or included in other engines of the system 400 (e.g., the vector engine 106 or the report engine 108).

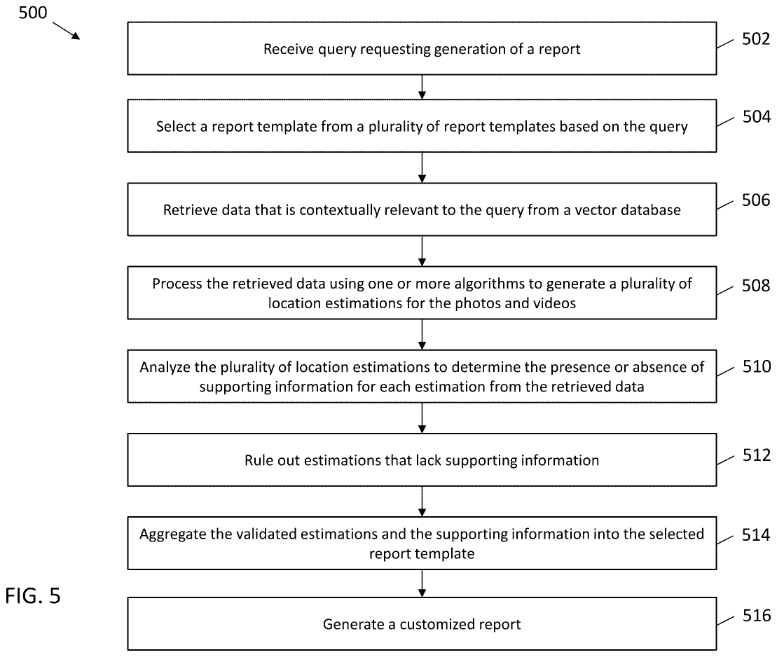

FIG. 5 is a flow diagram illustrating an example workflow 500 of the system 400 in accordance with aspects described herein. The method 500 is performed, in part, by the estimation engine 402 and the validation engine 404 of the system 400.

At step 502, the query engine 104 receives a query requesting generation of a report. In some examples, the query is received from a user (or users). However, in other examples, the query 114 is received from another system or service. In some examples, the query includes one or more photos or videos to be used for the generation of the report. The query may include an indication of a desired report type and one or more user-specific parameters. In some examples, the query corresponds to a generic report request. In such examples, the query engine 104 may prompt the user (e.g., via the UI) to upload photos/videos and enter (or select) a report type and one or more user-specific parameters. In some examples, the query includes a data source (or a link to a data source) that includes one or more photos to be used for the generation of the report.

At step 504, the query engine 104 selects a report template from the report database 110b (e.g., report template 200 of FIG. 2A). As described above, the report template may include a predefined set of parametrized prompt templates which are used to generate dynamic content for the report. In some examples, the query engine 104 is configured to generate a plurality of user-specific prompts based on a plurality of prompt templates corresponding to the selected report template and the at least one user-specific parameter.

At step 506, the vector engine 106 retrieves data from the vector database 110c that are contextually relevant to the query. The retrieved data may include data from a plurality of external sources, including social media posts, news articles, website content, and database content. In some examples, the vector engine 106 is configured to identify relevant vectors in the vector database 110c by performing a similarity search.

At step 508, the estimation engine 402 processes the retrieved data using one or more estimation algorithms to generate a plurality of location estimations for the photos and/or videos. In some examples, the estimation engine 402 performs image/video processing functions on the photos/videos to extract information that is used by the estimation algorithms. In some examples, the estimation algorithm includes, or is configured to interact with, one or more AI models or machine learning (ML) algorithms to generate the plurality of location estimates. In some examples, the plurality of locations estimates are scored or ranked based on a confidence level of the estimation algorithm.

At step 510, the validation engine 404 analyzes the plurality of location estimations to determine the presence or absence of supporting information for each estimation from the retrieved data. In some examples, the validation engine 404 analyzes the location estimations by retrieving qualitative data, such as news articles or social media posts, from the raw data database 110a and/or the vector database 110c that mention or discuss geographic locations near the estimated locations. In some examples, the qualitative data is included in the data retrieved from the vector database 110c in step 506. The validation engine 404 evaluates the retrieved data to determine whether the data supports or contradicts each location estimation. This involves comparing the content of the retrieved qualitative data with the details of the location estimations to identify any relevant matches or discrepancies. In some examples, the validation engine 404 uses a confidence metric to measure the presence or absence of supporting information for each estimation. The confidence metric quantifies the degree of alignment between the retrieved qualitative data and the location estimations. For example, if multiple sources of qualitative data consistently mention landmarks, events, or other geographic indicators that align with a specific location estimation, the confidence metric for that estimation will be higher. Conversely, if the qualitative data does not support (or contradicts) the location estimation, the confidence metric will be lower. This process ensures that each location estimation is validated based on the presence of corroborating information from reliable sources of qualitative data.

At step 512, the validation engine 404 is configured to rule out estimations from the plurality of location estimations that lack supporting information. In some examples, the validation engine 404 compares the confidence metrics generated in step 510 to one or more thresholds to rule out estimations. For example, if the confidence metric for an estimation falls below the threshold(s), that estimation may be eliminated from the plurality of location estimations.

At step 514, the report engine 108 aggregates the validated location estimations and the supporting information into the selected report template. The supporting information may include social or other media, such as news, which mentions or otherwise discusses the areas or landmarks in the vicinity of the estimated locations. In some examples, the report engine 108 is configured to provide the user-specific prompts and the supporting information to the LLM 109. The LLM 109 generates a plurality of answers corresponding to the plurality of user-specific prompts based on the supporting information that may be aggregated into the report template. In some examples, the LLM 109 is instructed (e.g., by the prompts of the report template) to summarize the supported information and derive additional insights. In some examples, the LLM 109 is instructed to generate the report content with a particular context. For example, the LLM 109 may be instructed to generate answers (or content) from the perspective of a reporter, an agent, a researcher, etc. In some examples, the LLM 109 is instructed to generate answers (or content) in two or more different languages (e.g., English, Chinese, French, etc.). Alternatively, the LLM 109 may be instructed to (i) generate the report and (ii) revise the report (e.g., add context/perspective, convert to different languages, etc.).

At step 516, the report engine 108 generates the customized report. In some examples, the report includes visualizations of the validated estimations and the supporting information. In some examples, the customized report is generated in a format compatible with existing government databases and systems. In some examples, the report includes a summary of the qualitative analysis performed by the validation engine. In some examples, the report engine 108 verifies (or assesses) the quality of the report. If the quality of the report is not satisfactory, the report engine 108 may revise the report accordingly, as discussed above in connection to the workflow 300 in FIG. 3.

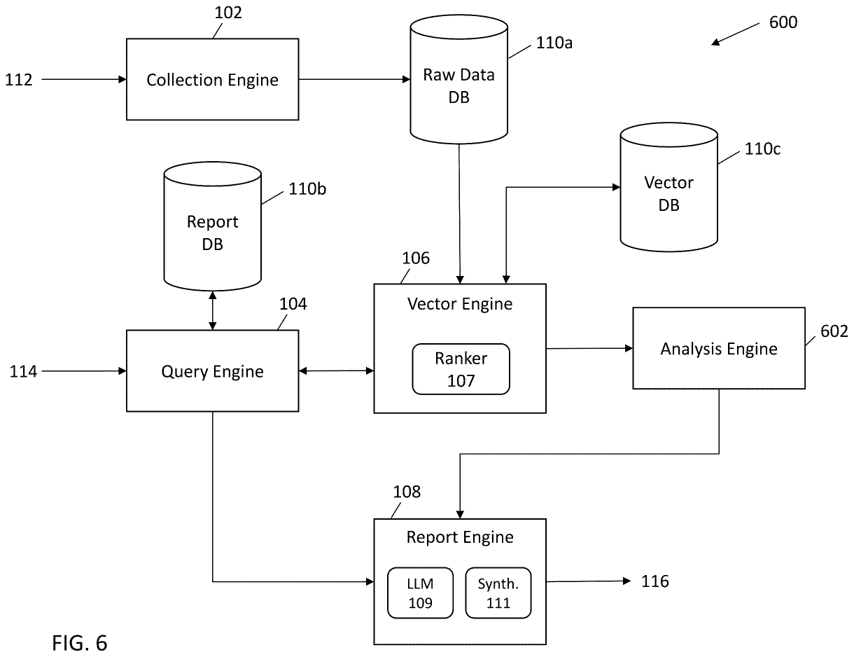

FIG. 6 is a block diagram of a report generation system 600 in accordance with aspects described herein. The system 600 is substantially the same as the system 100 of FIG. 1, except the system 600 includes an analysis engine 602. The analysis engine 602 may be a standalone engine or included in another engine of the system 600 (e.g., the vector engine 106 or the report engine 108).

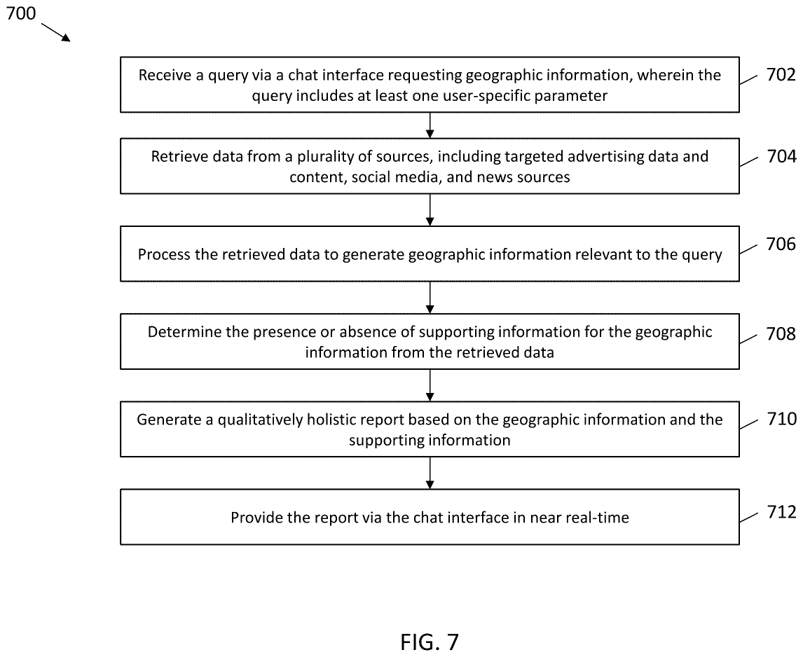

FIG. 7 is a flow diagram illustrating an example workflow 700 of the system 600 in accordance with aspects described herein. The method 700 is performed, in part, by the analysis engine 602 of the system 600. In some examples, the analysis engine 602 is included in another engine of the system 100 (e.g., the vector engine 106 or the report engine 108). In some examples, the analysis engine is a standalone engine of the system 100.

At step 702, the query engine 104 receives a query requesting information specific to a geographic location or region (e.g., “Please describe the military buildup of Country A troops in City A, Country B”). In some examples, the query is received from a user (or users) via a chat interface. The chat interface is configured to support real-time communication between the user and the system 100. The query may include an indication of a desired report type (or format for the geographic information and one or more user-specific parameters. In some examples, the query engine 104 is configured to generate a plurality of user-specific prompts based on a plurality of prompt templates corresponding to the user-specific parameters.

At step 704, the vector engine 106 retrieves data from the vector database 110c that are contextually relevant to the query. The retrieved data may include data from a plurality of external sources, including but not limited to targeted advertising data and content, social media, news sources, website content, and database content. In some examples, the vector engine 106 is configured to identify relevant vectors in the vector database 110c by performing a similarity search.

At step 706, the analysis engine 602 processes the retrieved data to generate geographic information relevant to the query. In some examples, the analysis engine 602 processes the retrieved data by matching the vectorized data to plain English queries that contain the desired answer (i.e., information specific to the location indicated in the query). In some examples, the analysis engine 602 includes, or is configured to interact with, one or more AI models or ML algorithms to generate the geographic information. For example, the AI model may be used to “post process” the answers in a manner that makes the answers visually interactive, more compelling, and more informative. In some examples, the analysis engine is configured to “post-process” the answers by matching analytic outputs from computer vision, network graphing, community detection, or other outputs that help make the answers visually interactive, more compelling, and more informative.

At step 708, the analysis engine 602 analyzes the retrieved data to determine the presence or absence of supporting information for the geographic information from the retrieved data. In some examples, the analysis engine 602 determines if the retrieved data matches or speaks to the location or region in the query. For example, if there is a picture of Country A troops in Country B, the supporting information about the presence of Country A troops in Country B would include social media posts mentioning or showing such, and news articles discussing it, and so on. In some examples, the analysis engine 602 uses a confidence metric to measure the presence or absence of supporting information for the geographic information. The confidence metric quantifies the degree of alignment between the supporting information and the location or region. For example, if multiple sources of data consistently mention landmarks, events, or other geographic indicators that align with the location/region, the confidence metric for that estimation will be higher. Conversely, if the data does not support (or contradicts) the location/region, the confidence metric will be lower. This process ensures that the supplemental information is validated based on the presence of corroborating information from reliable sources of data.

At step 710, the report engine 108 generates a qualitatively holistic report based on the geographic information and the supporting information. In some examples, the report engine 108 is configured to provide the user-specific prompts and the supporting information to the LLM 109. The LLM 109 generates a plurality of answers corresponding to the plurality of user-specific prompts based on the supporting information that may be aggregated into the report. In some examples, the LLM 109 is instructed (e.g., by the prompts of a report template) to summarize the supported information and derive additional insights. In some examples, the LLM 109 is instructed to generate the report content with a particular context. For example, the LLM 109 may be instructed to generate answers (or content) from the perspective of a reporter, an agent, a researcher, etc. In some examples, the LLM 109 is instructed to generate answers (or content) in two or more different languages (e.g., English, Chinese, French, etc.). Alternatively, the LLM 109 may be instructed to (i) generate the report and (ii) revise the report (e.g., add context/perspective, convert to different languages, etc.). In some examples, the report engine 108 verifies (or assesses) the quality of the report. If the quality of the report is not satisfactory, the report engine 108 may revise the report accordingly, as discussed above in connection to the workflow 300 in FIG. 3.

At step 712, the report engine 108 provides the report to the user via the chat interface. In some examples, the report is provides in near-real time. In some examples, the report includes visualizations of the geographic information and the supporting information. In some examples, the report includes a summary of the qualitative analysis performed by the analysis engine. In some examples, the report is generated in a format compatible with existing government databases and systems.

### Some Embodiments

Some embodiments may include any of the following:
A1. A system for automatically generating a report including a query engine configured to: receive a query requesting generation of a report, wherein the query includes a report type and at least one user-specific parameter; select a report template from a plurality of report templates based on the report type; and generate a plurality of user-specific prompts based on a plurality of prompt templates corresponding to the selected report template and the at least one user-specific parameter. The system includes a vector engine configured to retrieve data that is contextually relevant to the plurality of user-specific prompts from a vector database and a report engine configured to: provide the plurality of user-specific prompts and the retrieved data to a large language model (LLM); generate, via the LLM, a plurality of answers corresponding to the plurality of user-specific prompts based on the retrieved data; and aggregate the plurality of answers into the selected report template to produce the report.
A2. The system of clause A1, can include any of the following components or features, in any combination. A collection engine configured to: collect publicly-available information (PAI) data; and store the PAI data in a text database, wherein the vector engine is further configured to: vectorize the PAI data stored in the at least one text database by converting the PAI data from a text format to a numerical vector format; and store the vectorized PAI data in the vector database. The vector engine includes a chunking module configured to: segment the PAI data into a plurality of chunks based on a data type of the PAI data, wherein the segmenting includes: for PAI data having a text length within a predefined token limit, treating the PAI data as a single chunk; for PAI data having a text length exceeding the predefined token limit, dynamically splitting the PAI data by paragraph and sequentially aggregating paragraphs into chunks without exceeding the predefined token limit; and for PAI data comprising structured documents, splitting the PAI data in alignment with at least one of page boundaries and section headers. The vector engine is further configured to: apply one or more metadata filters to the vectorized PAI data stored in the vector database to identify a filtered subset of the vectorized PAI data; and perform an approximate nearest neighbor (ANN) search on the filtered subset to retrieve the data that is contextually relevant to the plurality of user-specific prompts. The vector engine is further configured to: selectively switch between the ANN search and an exact search based on a size of the filtered subset relative to at least one threshold parameter. The vector engine is further configured to: rank the vectorized PAI data based on a contextual relevance to the plurality of vectorized user-specific prompts. The vector engine includes a ranker module configured to: generate a plurality of rankings for the vectorized PAI data, wherein each ranking of the plurality of rankings corresponds to a respective user-specific prompt of the plurality of user-specific prompts. The vector engine is further configured to: vectorize the plurality of user-specific prompts by converting the plurality of user-specific prompts from a text format to a numerical vector format, wherein retrieving the data that is contextually relevant to the plurality of user-specific prompts from the vector database includes comparing the plurality of vectorized user-specific prompts to the vectorized PAI data stored in the vector. Generating the plurality of user-specific prompts based on the plurality of prompt templates includes integrating the at least one user-specific parameter into the plurality of prompt templates. The plurality of prompt templates include task-oriented instructions for the LLM. The plurality of prompt templates include instructions that instruct the LLM to generate predictions. The report engine is further configured to: generate at least one report metric for the report using a synthesizer; and determine whether the report meets at least one quality threshold based on the at least one report metric, wherein in response to determining that the report does not meet the at least one quality threshold, the report engine is further configured to: initiate an iterative refinement of the report by causing at least one of: (i) the query engine to select one or more different prompt templates for inclusion in the selected report template, (ii) the vector engine to vary a predetermined number of vectors provided to the LLM from the vector database, and (iii) the query engine to prompt a user to provide one or more additional user-specific parameters, wherein the LLM regenerates at least a portion of the report based on the iterative refinement. The at least one report metric includes a cosine similarity metric. The query engine is further configured to: automatically generate the plurality of prompt templates based on one or more example reports associated with the report type. An estimation engine configured to: process the retrieved data using one or more estimation algorithms to generate a plurality of location estimations for one or more photos or videos included in the query; and a validation engine configured to: analyze the plurality of location estimations to determine a presence or absence of supporting information for each location estimation from the retrieved data; and eliminate one or more location estimations from the plurality of location estimations that lack supporting information based on a confidence metric, wherein the report engine is further configured to aggregate the validated location estimations and the supporting information into the selected report template.
A3. A method for automatically generating a report including receiving a query requesting generation of a report, wherein the query includes a report type and at least one user-specific parameter; selecting a report template from a plurality of report templates based on the report type; generating a plurality of user-specific prompts based on a plurality of prompt templates corresponding to the selected report template and the at least one user-specific parameter; retrieving data that is contextually relevant to the plurality of user-specific prompts from a vector database; providing the plurality of user-specific prompts and the retrieved data to a large language model (LLM); generating, via the LLM, a plurality of answers corresponding to the plurality of user-specific prompts based on the retrieved data; and aggregating the plurality of answers into the selected report template to produce the report.

### Hardware and Software Implementations

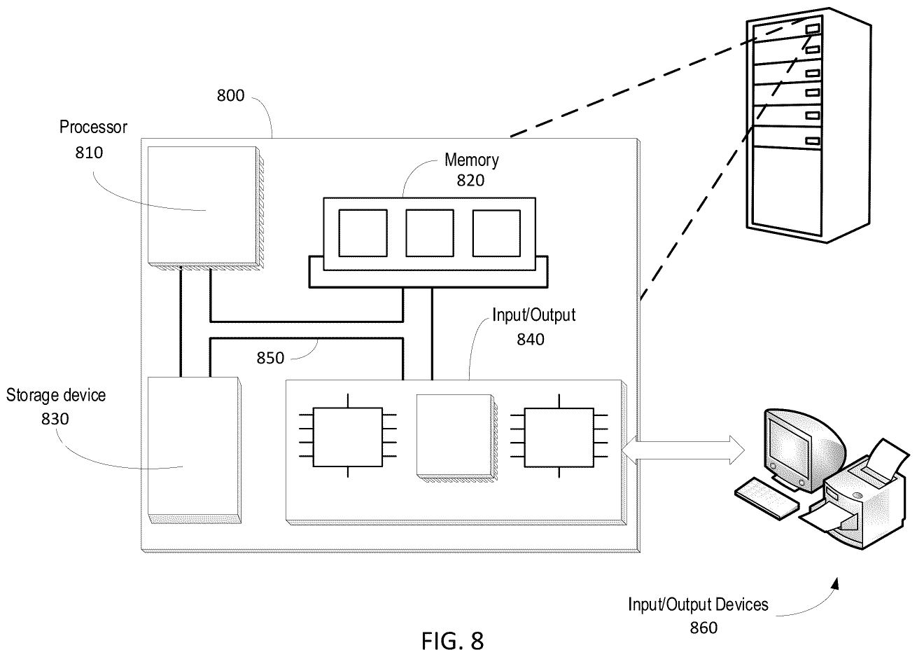

FIG. 8 is a block diagram of an example computer system 800 that may be used in implementing the systems and methods described herein. For example, one or more computer systems, such as the computer system 800, may be operable to perform the operations of the engines described in FIGS. 1, 4, and 6. General-purpose computers, network appliances, mobile devices, or other electronic systems may also include at least portions of the system 800. The system 800 includes a processor 810, a memory 820, a storage device 830, and an input/output device 840. Each of the components 810, 820, 830, and 840 may be interconnected, for example, using a system bus 850. The processor 810 is capable of processing instructions for execution within the system 800. In some implementations, the processor 810 is a single-threaded processor. In some implementations, the processor 810 is a multi-threaded processor. The processor 810 is capable of processing instructions stored in the memory 820 or on the storage device 830.

The memory 820 stores information within the system 800. In some implementations, the memory 820 is a non-transitory computer-readable medium. In some implementations, the memory 820 is a volatile memory unit. In some implementations, the memory 820 is a non-volatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 830 is capable of providing mass storage for the system 800. In some implementations, the storage device 830 is a non-transitory computer-readable medium. In various different implementations, the storage device 830 may include, for example, a hard disk device, an optical disk device, a solid-date drive, a flash drive, or some other large capacity storage device. For example, the storage device may store long-term data (e.g., database data, file system data, etc.). The input/output device 840 provides input/output operations for the system 800. In some implementations, the input/output device 840 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 860. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 830 may be implemented in a distributed way over a network, such as a server farm or a set of widely distributed servers, or may be implemented in a single computing device.

Although an example processing system has been described in FIG. 8, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

### Other Considerations

While this specification contains many specific implementation details, these should not be construed as limitations on the scope, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes.

The phraseology and terminology used herein is for the purpose of description and should not be regarded as limiting.

The indefinite articles “a” and “an,” as used in the specification, unless clearly indicated to the contrary, should be understood to mean “at least one.” The phrase “and/or,” as used in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. In general, the term “or” as used shall only be interpreted as indicating exclusive alternatives (i.e. “one or the other but not both”) when preceded by terms of exclusivity, such as “either,” “one of,” “only one of,” or “exactly one of.”

As used in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for automatically generating a report, comprising:
a query engine configured to:
receive a query requesting generation of a report, wherein the query includes a report type and at least one user-specific parameter;
select a report template from a plurality of report templates based on the report type; and
generate a plurality of user-specific prompts based on a plurality of prompt templates corresponding to the selected report template and the at least one user-specific parameter;
a vector engine configured to retrieve data that is contextually relevant to the plurality of user-specific prompts from a vector database; and
a report engine configured to:
provide the plurality of user-specific prompts and the retrieved data to a large language model (LLM);
generate, via the LLM, a plurality of answers corresponding to the plurality of user-specific prompts based on the retrieved data; and
aggregate the plurality of answers into the selected report template to produce the report.

2. The system of claim 1, further comprising:
a collection engine configured to:
collect publicly-available information (PAI) data; and
store the PAI data in a text database,
wherein the vector engine is further configured to:
vectorize the PAI data stored in the at least one text database by converting the PAI data from a text format to a numerical vector format; and
store the vectorized PAI data in the vector database.

3. The system of claim 2, wherein the vector engine comprises a chunking module configured to:
segment the PAI data into a plurality of chunks based on a data type of the PAI data, wherein the segmenting includes:
for PAI data having a text length within a predefined token limit, treating the PAI data as a single chunk;
for PAI data having a text length exceeding the predefined token limit, dynamically splitting the PAI data by paragraph and sequentially aggregating paragraphs into chunks without exceeding the predefined token limit; and
for PAI data comprising structured documents, splitting the PAI data in alignment with at least one of page boundaries and section headers.

4. The system of claim 2, wherein the vector engine is further configured to:
apply one or more metadata filters to the vectorized PAI data stored in the vector database to identify a filtered subset of the vectorized PAI data; and
perform an approximate nearest neighbor (ANN) search on the filtered subset to retrieve the data that is contextually relevant to the plurality of user-specific prompts.

5. The system of claim 4, wherein the vector engine is further configured to:
selectively switch between the ANN search and an exact search based on a size of the filtered subset relative to at least one threshold parameter.

6. The system of claim 2, wherein the vector engine is further configured to:
rank the vectorized PAI data based on a contextual relevance to the plurality of vectorized user-specific prompts.

7. The system of claim 6, wherein the vector engine comprises a ranker module configured to:
generate a plurality of rankings for the vectorized PAI data, wherein each ranking of the plurality of rankings corresponds to a respective user-specific prompt of the plurality of user-specific prompts.

8. The system of claim 1, wherein generating the plurality of user-specific prompts based on the plurality of prompt templates comprises integrating the at least one user-specific parameter into the plurality of prompt templates.

9. The system of claim 1, wherein the report engine is further configured to:
generate at least one report metric for the report using a synthesizer; and
determine whether the report meets at least one quality threshold based on the at least one report metric,
wherein in response to determining that the report does not meet the at least one quality threshold, the report engine is further configured to:
initiate an iterative refinement of the report by causing at least one of:
(i) the query engine to select one or more different prompt templates for inclusion in the selected report template,
(ii) the vector engine to vary a predetermined number of vectors provided to the LLM from the vector database, and
(iii) the query engine to prompt a user to provide one or more additional user-specific parameters,
wherein the LLM regenerates at least a portion of the report based on the iterative refinement.

10. The system of claim 1, further comprising:
an estimation engine configured to:
process the retrieved data using one or more estimation algorithms to generate a plurality of location estimations for one or more photos or videos included in the query; and
a validation engine configured to:
analyze the plurality of location estimations to determine a presence or absence of supporting information for each location estimation from the retrieved data; and
eliminate one or more location estimations from the plurality of location estimations that lack supporting information based on a confidence metric, wherein the report engine is further configured to aggregate the validated location estimations and the supporting information into the selected report template.

11. A method for automatically generating a report, comprising:
receiving a query requesting generation of a report, wherein the query includes a report type and at least one user-specific parameter;
selecting a report template from a plurality of report templates based on the report type;
generating a plurality of user-specific prompts based on a plurality of prompt templates corresponding to the selected report template and the at least one user-specific parameter;
retrieving data that is contextually relevant to the plurality of user-specific prompts from a vector database;
providing the plurality of user-specific prompts and the retrieved data to a large language model (LLM);
generating, via the LLM, a plurality of answers corresponding to the plurality of user-specific prompts based on the retrieved data; and
aggregating the plurality of answers into the selected report template to produce the report.

12. The method of claim 11, further comprising:
collecting publicly-available information (PAI) data;
storing the PAI data in a text database,
vectorizing the PAI data stored in the at least one text database by converting the PAI data from a text format to a numerical vector format; and
storing the vectorized PAI data in the vector database.

13. The method of claim 12, further comprising:
segmenting the PAI data into a plurality of chunks based on a data type of the PAI data, wherein the segmenting includes:
for PAI data having a text length within a predefined token limit, treating the PAI data as a single chunk;
for PAI data having a text length exceeding the predefined token limit, dynamically splitting the PAI data by paragraph and sequentially aggregating paragraphs into chunks without exceeding the predefined token limit; and
for PAI data comprising structured documents, splitting the PAI data in alignment with at least one of page boundaries and section headers.

14. The method of claim 12, further comprising:
applying one or more metadata filters to the vectorized PAI data stored in the vector database to identify a filtered subset of the vectorized PAI data; and
performing an approximate nearest neighbor (ANN) search on the filtered subset to retrieve the data that is contextually relevant to the plurality of user-specific prompts.

15. The method of claim 14, further comprising:
selectively switching between the ANN search and an exact search based on a size of the filtered subset relative to at least one threshold parameter.

16. The method of claim 12, further comprising:
ranking the vectorized PAI data based on a contextual relevance to the plurality of vectorized user-specific prompts.

17. The method of claim 16, further comprising:
generating a plurality of rankings for the vectorized PAI data, wherein each ranking of the plurality of rankings corresponds to a respective user-specific prompt of the plurality of user-specific prompts.

18. The method of claim 11, wherein generating the plurality of user-specific prompts based on the plurality of prompt templates comprises integrating the at least one user-specific parameter into the plurality of prompt templates.

19. The method of claim 11, further comprising:
generating at least one report metric for the report using a synthesizer; and
determining whether the report meets at least one quality threshold based on the at least one report metric,
wherein in response to determining that the report does not meet the at least one quality threshold:
initiating an iterative refinement of the report by causing at least one of:
(i) selecting one or more different prompt templates for inclusion in the selected report template,
(ii) varying a predetermined number of vectors provided to the LLM from the vector database, and
(iii) prompting a user to provide one or more additional user-specific parameters,
wherein the LLM regenerates at least a portion of the report based on the iterative refinement.

20. The method of claim 11, further comprising:
processing the retrieved data using one or more estimation algorithms to generate a plurality of location estimations for one or more photos or videos included in the query;
analyzing the plurality of location estimations to determine a presence or absence of supporting information for each location estimation from the retrieved data;
eliminating one or more location estimations from the plurality of location estimations that lack supporting information based on a confidence metric; and
aggregating the validated location estimations and the supporting information into the selected report template.
